(19) United States
(12) Patent Application Publication
(10) Pub. No.: US 2012/0204564 A1
(43) Pub. Date: Aug. 16, 2012

(54) SOLAR ELECTRIC GENERATOR

(76) Inventor: Alex Battaglia, San Diego, CA (US)

(21) Appl. No.: 13/498,752

(22) PCT Filed: Oct. 5, 2010
(86) PCT No.: PCT/US10/51498

§ 371 Date: May 3, 2012

(30) Foreign Application Priority Data
Oct. 5, 2009 (US) 61248829

(51) Int. Cl. H02N 10/00; H02K 15/00; F03G 6/00

(52) U.S. Cl. 60/641.8; 29/596

(57) ABSTRACT

A solar electric generator is disclosed that includes a sealed cylindrical casing having a depression in the cylindrical wall, the casing being made of a material that allows the energy of sunlight therethrough, a magnetic wire coiled in the depression, a strut positioned within the casing along a center axis, and a plurality of magnetized vanes configured to rotate (with low friction) on the strut proximate the depression, the vanes having a black side and a white side, an outer portion of the vane being shaped to correspond to the depression in the casing. Other embodiments and methods of generating an alternating current are also disclosed.

### BACKGROUND OF THE INVENTION

1. Field of the Invention

The invention relates generally to alternative energy, and more specifically to use solar energy to generate an electric current.

2. Background Information

The Crookes radiometer, also known as the light mill or solar engine, consists of an airtight glass bulb, containing a partial vacuum. Inside are a set of vanes that are mounted on a spindle, which rotates when exposed to light. The reason for the rotation has been the cause of much scientific debate.

The radiometer was invented in 1873 by the chemist, Sir William Crookes, as the by-product of chemical research. In the course of very accurate quantitative chemical work, Crooke was weighing samples in a partially evacuated chamber to reduce the effect of air currents, and noticed the weighings were disturbed when sunlight shone on the balance. Investigating this effect, Crooke created the device, which is still manufactured and sold to this day as a curiosity item.

Today's radiometer is made from a glass bulb from which much of the air has been removed to form a partial vacuum. Inside the bulb, on a low friction spindle, is a rotor with several (usually four) vertical lightweight metal vanes spaced equally around the axis. The vanes are polished or painted white on one side, and black on the other. When exposed to sunlight, artificial light, or infrared radiation (even the heat of a hand nearby can be enough), the vanes turn with no apparent motive power, the dark sides retreating from the radiation source and the light sides advancing. Cooling the radiometer causes rotation in the opposite direction.

The rotational effect begins at partial vacuum pressures of a few millimeters of mercury (torr), reaches a peak at around 10⁻² torr, and has disappeared by the time the vacuum reaches 10⁻⁶ torr. At these very high vacuums the effect of photon radiation pressure on the vanes can be observed in a very sensitive apparatus, but the radiation pressure is insufficient to cause rotation.

The Crookes radiometer therefore appears to be a potent source of useful energy. Previous attention has been placed on attaching the vanes of the radiometer to a circuit connected to a condensor which accumulates electrical energy (See U.S. Pat. Nos. 359,748, 406,968, and 4,397,150, incorporated herein by reference). However, the apparatus described in U.S. Pat. No. 359,748 does not depend on the rotation of magnets and leads to a dramatic decrease in efficiency. In U.S. Pat. Nos. 406,968 and 4,397,150, incorporation of rotating gears leads to a dramatic decrease in efficiency due to friction from the rotation of the gears. Other solutions have been proposed as well. For example, creating larger radiometers and/or placing radiometers in space has also been proposed. However, all of the previously described methods have not been successfully pursued due to the inefficiency of producing the electric current. Accordingly, the present invention solves the problems of the prior art by efficiently producing a usable electric current based on the principles of the radiometer.

### SUMMARY OF THE INVENTION

The invention describes an efficient way of converting solar power into a useful electric current using a solar electric generator. In one embodiment, the solar electric generator includes a sealed cylindrical casing having a depression within the cylindrical wall, the casing being made of a material that allows the energy of sunlight pass through the casing, magnet wire coiled in the depression, a strut or hub positioned within the casing along a center axis designed to minimize friction, and a plurality of magnetized vanes configured to rotate on the strut or hub proximate to the depression, the vanes having a black side and a white side and an outer portion of the vane being shaped to correspond to the depression in the casing.

In another embodiment, the solar electric generator includes a sealed cylindrical casing, the casing being made of a material that allows the energy of sunlight pass through the casing and also allows the internal temperature of the cylinder to equilibrate with ambient temperature. An axle is located within the sealed casing along a central vertical axis of the casing. A magnet wire is coiled along a length of the axle, and a plurality of bearings are located on the axle beyond the length of coiled magnet wire flanking the coil of magnet wire. A tubular magnet with alternating poles, the center hollow portion of which is disposed for attachment to the axle by contacting with the bearings, is located over the length of magnet wire. A plurality of vanes having white and black sides, as provided above, are configured to power the rotation of the tubular magnet around the axle. In one embodiment, the bearings are designed to minimize friction during rotation of the tubular magnet. In another embodiment, the bearings are ceramic. In another embodiment, the axle is a hollow tube, thereby providing a passage through which the leads of the magnet wire may pass an electrical current. In yet another embodiment, the casing is of a strength that can withstand the internal vacuum within the casing, as provided below.

In another aspect, the invention provides a method of producing alternating current (AC). In one embodiment, the method includes positioning a plurality of alternately positioned magnetized vanes on a strut or hub within a sealed cylindrical casing having a depression in the cylindrical wall, the vanes having a white side and a black side, an outer portion of the vanes being shaped to correspond to the depression in the casing, coiling a magnetic wire within the depression, and exposing the vanes to light to create a pressure differential between the black and white sides of the vanes and rotate the plurality of alternately positioned magnetized vanes, thereby creating AC.

In another embodiment, the method includes positioning a plurality of alternately positioned vanes on a tubular magnet with alternating poles, the hollow portion of which is mounted on ceramic bearings designed to minimize friction which in turn is attached to the center axis within a sealed cylindrical casing, the vanes having a white side and a black side, coiling a magnetic wire along a center axis of the casing, and exposing the vanes to light to create a pressure differential between the black and white sides of the vanes and rotate the plurality of alternately positioned vanes, thereby creating AC.

### BRIEF DESCRIPTION OF THE DRAWINGS

FIG. 1 shows one embodiment of a solar electric generator.

FIG. 2 shows another embodiment of a solar electric generator.

FIG. 3 shows yet another embodiment of a solar electric generator.

### DETAILED DESCRIPTION OF THE INVENTION

The invention describes an efficient way of converting solar power into an electric current using the principles of a Crooke's radiometer. Over the years, engineers and scientists have wondered first how the radiometer works and second how to use it to efficiently create power. Previous attention has been placed on attaching the vanes of the radiometer to a rotating shaft (and gearboxes) connected to electromagnets. The SEG (Solar Electric Generator) is based on the Crooke's radiometer, but optimizes the force pushing magnetized vanes while minimizing the friction opposing the rotation of the radiometer's magnetized vanes.

In one embodiment, the SEG includes a sealed cylindrical casing having a depression within the cylindrical wall, the casing being made of a material that allows the energy of sunlight pass through the casing, magnet wire coiled in the depression, and a strut or hub positioned within the casing along a center axis. The joint between the strut and the hub of the vanes needs to provide absolute stability while also allowing rotation with minimal resistance. A plurality of alternately positioned magnetized vanes configured to rotate on the strut or hub proximate to the depression are equally spaced around the circumference of the hub. The vanes are configured to have a black side and a white side, with the outer portion of the vane being shaped to correspond to the depression in the casing.

In another embodiment, the SEG includes a sealed cylindrical casing having a raised surface, bulge, expansion, or protrusion extending outwardly along the axis of rotation of the magnetized vanes. In this embodiment, magnet wire is coiled on the raised surface, bulge, expansion, or protrusion. A plurality of alternately positioned magnetized vanes configured to rotate on the strut or hub proximate to the raised surface, bulge, expansion, or protrusion are equally spaced around the circumference of the hub. The vanes are configured to have a black side and a white side, with the outer portion of the vane being shaped to correspond to the depression in the casing.

Another advantage of the SEG is that it produces alternating current (AC), which is used in currently existing distribution grids, whereas currently used methods of harnessing the sun's energy (i.e., solar panels) produce direct current (DC) which incurs an energy loss of 4-12% when converted to DC.

### Thermodynamics of a Radiometer

External Radiant Source Motion

For any heat engine to turn, there must be a difference in temperature. In this case, the black side of the vane is hotter than the other side of the vane, as radiant energy from a light source warms the black side by black-body absorption faster than the silver or white side. The air molecules within the casing are subsequently “heated up” (i.e., experience an increase in speed) as they touch or move near the black side of the vane. The details regarding how this moves the hotter side of the vane forward are given in the section below Explanations for the force on the vanes.

The internal temperature of the casing rises as the black vanes impart heat to the gas molecules within the partial vacuum. However, as the gas molecules touch the casing's surface, which is at ambient temperature, they are cooled. Heat loss through the glass keeps the temperature within the casing steady such that the two sides of the vanes can develop a temperature difference. The closer the casing is to the vanes, the better heat dissipation. The white part of the vanes are therefore slightly warmer than the internal gas temperature but cooler than the black side of the vanes, as some heat conducts through the vane from the black side to the white side. Accordingly, the two sides of each vane should be thermally insulated to some degree so that the silver or white side does not immediately reach the temperature of the black side.

A hard vacuum inside the casing does not permit motion because there are not enough gas molecules involved in thermal creep to cause enough secondary differences in gas pressure that move the vanes. In contrast, higher inside pressures do not permit rotation of the hub because not enough thermal creep to the black side of the vanes occurs.

Motion without External Radiation

Heating the radiometer in the absence of a light source, results in the hub turning in the forward direction (i.e. the black sides trailing). For example, heat from human hands placed around, but not quite touching the casing will result in a slow or no rotations, but if the casing is touched directly to warm it quickly, the hub will turn more noticeably. Thus, the directly heated casing gives off enough infrared radiation to turn the vanes, but if the hands are not touching the casing, the material from which the casing is made (e.g., glass) blocks much of the far-infrared radiation. Accordingly, near-infrared and visible light more easily penetrate the casing.

Cooling the radiometer quickly in the absence of a strong light source results in the hub turning backwards (i.e., the white/silver sides trailing). This demonstrates black-body radiation from the black sides of the vanes rather than black-body absorption. Thus, the hub rotates backwards because the black sides give off more heat and cools more quickly than the white/silver side.

The Force on the Vanes

Over the years, there have been many attempts to explain how a Crookes radiometer works. For example, Crookes incorrectly suggested that the force was due to the pressure of light. This theory was originally supported by James Clerk Maxwell who had predicted this force. The first experiment to disprove Maxwell's theory was done by Arthur Schuster in 1876, who observed that there was a force on the glass bulb of the Crookes radiometer that was in the opposite direction to the rotation of the vanes. Schuster's experiment showed that the force turning the vanes was generated inside the radiometer. If light pressure was the cause of the rotation, then the better the vacuum in the bulb, the less air resistance to movement, and the faster the vanes should spin. In 1901, with a better vacuum pump, Pyotr Lebedev showed that in fact, the radiometer only works when there is low pressure gas in the bulb, and the vanes stay motionless in a hard vacuum. Finally, if light pressure were the motive force, the radiometer would spin in the opposite direction as the photons on the shiny side being reflected would deposit more momentum than on the black side where the photons are absorbed.

Another incorrect theory was that the heat on the dark side was causing the material to outgas, which pushed the radiometer around. This was effectively disproved by both Schuster's and Lebedev's experiments.

A partial explanation is that gas molecules hitting the warmer side of the vane will pick up some of the heat, i.e., will bounce off the vane with increased speed. Giving the molecule this extra boost effectively means that a minute pressure is exerted on the vane. The imbalance of this effect between the warmer black side and the cooler white side means the net pressure on the vane is equivalent to a push on the black side, and as a result the vanes spin round with the black side trailing. The problem with this idea is that while the faster moving molecules produce more force, they also do a better job of stopping other molecules from reaching the vane, so the force on the vane should be exactly the same—the greater temperature causes a decrease in local density which results in the same force on both sides. Years after this explanation was dismissed, Albert Einstein showed that the two pressures do not cancel out exactly at the edges of the vanes because of the temperature difference there. The force predicted by Einstein would be enough to move the vanes, but not fast enough.

The final piece of the puzzle, “thermal creep” transpiration, was theorized by Osborne Reynolds, but first published by James Clerk Maxwell in the last paper before his death in 1879. Reynolds found that if a porous plate is kept hotter on one side than the other, the interactions between gas molecules and the plates are such that gas will flow through from the cooler to the hotter side. The vanes of a typical Crookes radiometer are not porous, but the space past their edges behave like the pores in Reynolds' plate. On average, the gas molecules move from the cold side toward the hot side whenever the pressure on the hot side allows it. The pressure difference causes the vane to move cold (white) side forward.

Another way of explaining this is as follows: The forces that arise on the vanes of the radiometer come from the so-called “thermal creep” of gas molecules that occurs over the surface of an unequally heated body. The black sides of the vanes absorb more heat energy from the light than do the white (or silver) sides, so the black sides are slightly warmer than the white sides. Gas molecules near a surface tend to approach its temperature. The gas molecules diffuse preferentially in the direction of increasing temperature (from near the white side to near the black side of the vanes). This “thermal creep” causes a slight increase in pressure on the warmer (black) sides of the vanes. If this force overcomes the static friction at the pivot and the gas resistance, the vanes turn in the direction faced by the white sides.

The degree of “thermal creep” is described by Maxwell in his original paper, and equals T_{bw}a/pr³, where T_{bw} is the difference in temperature between the black and white sides of the vanes, a is ½ the edge area, p is the vacuum pressure and r is the thickness of the vanes. This equation applies only when √T_{black}/density_{blackgas}>√T_{white}/density_{whitegas}, where “T” is the temperature on the black or white sides of the vanes, respectively, and “density” is the density of the gas on the black or white sides of the vanes, respectively. “Thermal creep” is therefore proportional to the temperature differences between the vanes and also to the edge area, and is inversely proportional to the thickness of the vanes as well as to the vacuum. These are critical variables.

Boltzmann's later description of the distribution characteristics of molecules of an ideal gas indicates that the mass of the gas is another important variable. According to Boltzmann, the smaller the mass of the gas molecules, the more acceleration that the molecules undergoing ‘thermal creep’ will experience, and the more these molecules will be pulled along the temperature gradient over the edge of the vane to the black side, assuming that all other variables are equal. The gas viscosity, or the resistance to flow, becomes important under non-ideal conditions. Thus, in addition to the variables pointed out by Maxwell, the smaller the atomic mass (e.g., 1 as in hydrogen or 2 as in helium, 20 as in neon, including up to 131 as in xeon), and the smaller the viscosity, the more ‘thermal creep’ will take place, and the more molecules will travel to the black side of the vane. An exemplary gas viscosity range is from about 0.00013 to 0.00020, as shown in Table 1.

TABLE 1

| Gas | Viscosity (poise) |
|---|---|
| Air | 0.00018 |
| Helium | 0.00019 |
| Methane | 0.00020 |
| Nitrogen | 0.00018 |
| Oxygen | 0.00020 |
| Water vapor (steam) | 0.00013 |

Viscosity has the SI units Pascal-seconds (Pa s) which is called the Poiseuille. More commonly used is the dyne sec/cm² which is called Poise. One Pa s is equal to 10 Poise. The Poise is used in the table because of its more common usage. Viscosities are at 20° C. except for steam which, is at 100° C.

“Thermal creep” then creates pressure differences between the black and white vanes, specifically at the edges of the vanes. The pressure on each side of the vane can be described with the use of the ideal gas law P=(NRT)/V, and in the case of the SEG, in which there may be rarefied gases, the force pushing each vane is therefore proportional to the pressure differences on the black and white sides of the vanes at the edges: Fᵥₐₙₑ˜(P_{black}−P_{white}). Accordingly, removing the constants (R and V), and subtracting the force of friction, the force pushing the SEG is proportional to the following:

F_{SEG}˜(Edge area/vane)×(#vanes)×[(Temp_{blackgas}×N_{blackgas)-(Temp}_{whitegas}×N_{whitegas})]−μF_{friction}

where (Edge area/vane) refers to the functional edge area per vane, (# vanes) refers to the number of vanes in the SEG, (Temp_{blackgas}) is the temperature of the gas at the black side of the vane, (N_{blackgas}) is the number of gas molecules on the black side of the vane at the edges, (Temp_{whitegas}) is the temperature of the gas on the white side of the vane, (N_{whitegas}) is the number of gas molecules on the white side of the vane at the edges, (μ) is the coefficient of friction at the hub and (F_{friction}) is the force of the friction at the hub. Over time, the temperature difference between the two sides of the vane will be: ((solar absorption of black surface minus heat loss of black surface)/(mass×specific heat))−((solar absorption of white surface minus heat loss of white surface)/(mass×specific heat)). Heat is then transferred from the black surface to the gas molecules and not to the substance of the vane. As such, the temperature of the entire vane remains low. Thus, the driving force of the SEG depends upon three primary variables: 1) maximizing the edge area of the vanes; 2) maximizing the temperature difference between the sides of the vanes; and 3) minimizing the friction at the hub.

Accordingly, the construction of the vanes and the hub are of utmost importance, in addition to the construction of the casing and wiring, the degree of vacuum, and the characteristics of the gas in the SEG.

In one embodiment, the vane is comprised of a lightweight insulating substance with a high specific heat and low thermal conductivity (e.g., cork, rubber, Styrofoam, aerogel, silica fibres, etc.), such that the surface resists heat absorption and likewise does not transmit heat. In another embodiment, one side of the vane is coated with a black, lightweight substance with a low specific heat and high thermal conductivity (e.g., carbon black) such that the surface efficiently absorbs heat and readily transmits heat to the surrounding gas. In another embodiment, magnets are attached to the vanes, and should be placed in as close proximity to the magnet wire on the outside of the casing as possible (e.g., on the outer edges of the vanes). The magnets (e.g., neodymium) should be as strong as possible, while minimizing the weight of the vanes. In another embodiment, the vanes are rectangular in order to maximize edge area, and to minimize the radius of the vanes which will in turn increase their r.p.m's exponentially. In another embodiment, the vanes are very thin in order to maximize thermal creep, between 0.1 to 10 cm. In another embodiment, the vanes are porous so as to maximize the effect of thermal creep at the edges of the pores, provided that the temperature difference between the sides of the vanes is maintained. As such, the pores maximize the functional edge area of each vane while allowing the passage therethrough of gas. In one embodiment, the vanes are made from a wire mesh. Exemplary pore sizes range from sub-microns to microns to millimeters. The number of vanes may also be maximized with the proviso that the temperature differences between the sides of the vanes are maintained. In another emodiment, diametrically charged tube magnets with a hub of ceramic bearings attached to a rigid strut coiled with magnet wire are used to facilitate rotation.

The gas within the casing of the SEG should have a low mass and low viscosity, low specific heat and high thermal conductivity. In one embodiment, the gas is inert. Exemplary gases for use in the SEG include, but are not limited to, Helium, Neon, Argon, Krypton Xeon, and Nitrogen.

The friction at the hub will increase as the overall weight of the hub and the vanes (hereinafter referred to as “the Engine” of the SEG) increases. Accordingly, the friction at the hub should be minimized as much as possible. The lower the static and kinetic coefficients of friction, the better. Exemplary static and kinetic coefficients of friction range from about 0.001 to 0.1, as shown in Table 2, and may go up to 0.9.

TABLE 2
Coefficients of Friction

| Material | Static | Kinetic |
|---|---|---|
| steel on steel | 0.74 | 0.57 |
| aluminum on steel | 0.61 | 0.47 |
| copper on steel | 0.53 | 0.36 |
| rubber on concrete | 1.0 | 0.8 |
| wood on wood | 0.25-0.5 | 0.2 |
| glass on glass | 0.94 | 0.4 |
| waxed wood on wet snow | 0.14 | 0.1 |
| waxed wood on dry snow | 0.04 | |
| metal on metal (lubricated) | 0.15 | 0.06 |
| ice on ice | 0.1 | 0.03 |
| teflon on teflon | 0.04 | 0.04 |
| synovial joints in humans | 0.01 | 0.003 |

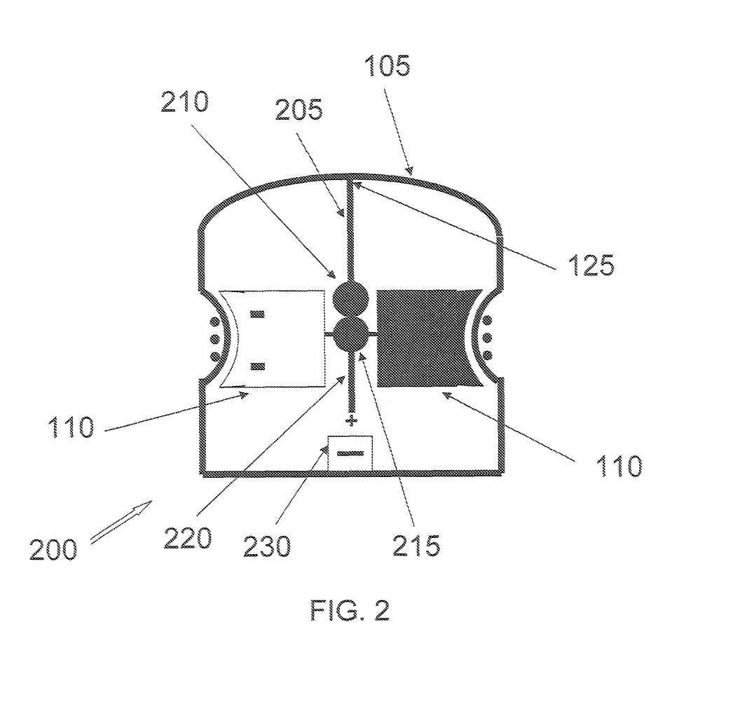

In one embodiment, a magnetized hub, as described below, is used in the SEG to minimize friction as weight increases. In another embodiment, the magnetized hub further depends upon a wobble prevention mechanism to maintain a true center and prevent any inherent wobble in the spinning hub. The wobble prevention mechanism is exemplified by, but not limited to, a magnetic counterbalance 220 attached longitudinally to the center of the hub 215 as shown in FIG. 2. The magnetic counterbalance 220 has an opposite polarity of a magnetic anti-wobble base 230, which acts to stabilize the hub 215 of the SEG while it spins but is not connected to the counterbalance. The magnetic pull of the anti-wobble base 230 should not be excessively strong as to significantly oppose the spin of the hub, but should be strong enough to prevent wobble. Alternatively, in another embodiment, a non-magnetic counterbalance attached to the hub 215 can be stabilized within a non-magnetic anti-wobble hub attached to the center of the base of the SEG. This anti-wobble hub or casing is loosely fitted to the non-magnetic counterbalance, preventing the hub from wobbling with minimal friction, thus allowing the engine of the SEG to maintain a true center. In another embodiment, the engine of the hub is suspended by spin-stabilized magnetic levitation in accordance with the levitation device disclosed in U.S. Pat. No. 4,382,245, the entire content of which is incorporated herein by reference. In another emodiment, the vanes are attached to rotating diametrically charged tube magnets with a hub of ceramic bearings which are further attached to a rigid strut coiled with magnet wire, thereby facilitating rotation of the vanes by minimizing fricition. In another emodiment, the vanes are attached to a rotating strut coiled with magnet wire which is further attached to a hub of ceramic bearings within a diametrically charged tube magnet, thereby facilitating rotation of the vanes by minimizing inertia and friction.

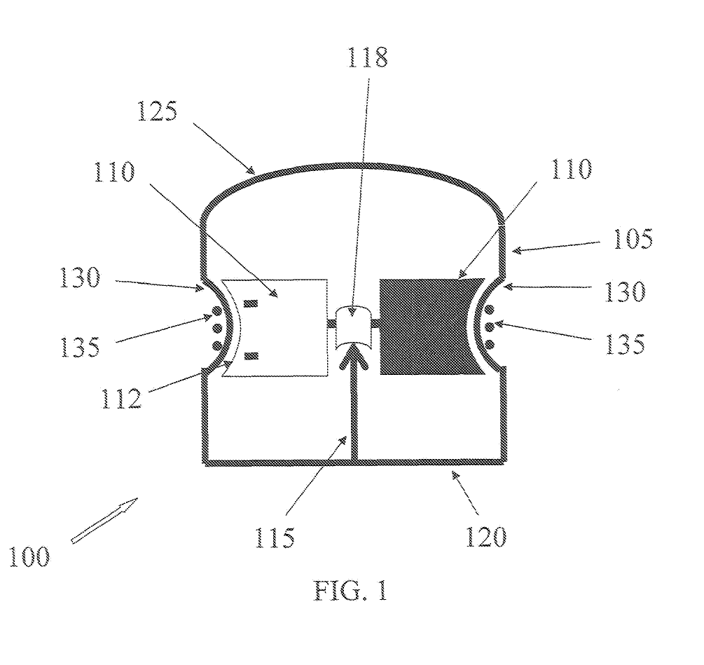

FIG. 1 shows one embodiment of the solar electric generator (SEG) 100 having a casing 105 covering one or more vanes 110 circumferentially mounted to hub 118, which is configured to rotate on a strut 115 positioned on a base 120 along a center axis. The vanes 110 have a black side (+) and a white side (−). In one embodiment, the casing 105 is approximately 10 cm high with a dome-like top 125, and is 7 cm in diameter. The casing 105 also has a depression 130 proximate to the rotating vanes 110, approximately 2.75 cm from the base 120. The casing 105 is made of a material that maximizes penetration by light while minimizing reflected light and minimizes proximity to the vanes, and should be proximate to the vanes. Exemplary materials for constructing the casing include, but are not limited to glass, acrylic, PYREX® polystyrene, and other transparent but strong plastics that readily transmit heat. The casing 105 may be sealed and should be strong enough to hold a vacuum between about 10-60 microtorr.

Magnet wire 135 is coiled in the depression 130 of the casing 105. In one embodiment, the magnetic wire 135 is a copper wire. Exemplary wires useful in the SEG include, but are not limited to, silver, gold, aluminum, steel, tin and zinc. In one embodiment, about 200-300 (e.g., 200, 220, 240, 260, 280, 300, etc.) feet or more of insulated magnetic copper wire 135 is coiled in the depression 130 of the casing 105. In another embodiment, 1000-5000 feet of wire 135 is coiled in the depression. One of skill in the art would understand that the number of coils required depends on a variety of factors including, but not limited to, the strength of the electromagnetic field, the gauge of the wire, the distance between the coil and the rotating vanes, the number of coils, the direction of the coils, etc. In one embodiment, depression 130 is situated such that the coiled wire 135 is located as close to the vanes 110 as possible. One of skill in the art would understand that the gauge (i.e., width or diameter) of the wire would also determine the number of windings necessary for use in the invention. Further, the total area of the wire must also be taken into consideration.

As used herein, “magnet wire” refers to an electrical conductor that when wound into a coil and energized creates a useful electrical field.

Magnetized vanes 110 are positioned on the strut 115 to rotate proximate to the depression 130 of the casing 105. An outer portion 112 of the vane 110 is shaped to correspond to the depression 130 in the casing 105. This allows the vane 110 to rotate as close as possible to the magnetic wire 135. The number and placement of the vanes 110 are selected to allow the vanes to rotate on the strut with almost zero friction. In one embodiment, four strongly magnetized, light weight, perfectly balanced vanes 110 are spaced equally around hub 118, which rotates on the strut 115 with almost zero friction, oriented with apposed poles.

In one embodiment, the temperature differential between the black side of the vane (+) and the white side of the vane (−) is maximized by coating each side with materials that have low and high specific heats, respectively. Specific heat capacity, also known simply as specific heat, is the measure of the heat energy required to increase the temperature of a unit quantity of a substance by a certain temperature interval. Exemplary specific heats are shown in Table 3.

TABLE 3
Specific Heat Capacities

| | | cₚ | Cₚ | Cᵥ |
|---|---|---|---|---|
| | | J g⁻¹ | J mol⁻¹ | J mol⁻¹ |
| Substance | Phase | K⁻¹ | K⁻¹ | K⁻¹ |
| Air (Sea level, | gas | 1.0035 | 29.07 | |
| dry, 0° C.) | | | | |
| Air (typical room | gas | 1.012 | 29.19 | |
| conditions^{A}) | | | | |
| Aluminium | solid | 0.897 | 24.2 | |
| Ammonia | liquid | 4.700 | 80.08 | |
| Antimony | solid | 0.207 | 25.2 | |
| Argon | gas | 0.5203 | 20.7862 | 12.4717 |
| Arsenic | solid | 0.328 | 24.6 | |
| Beryllium | solid | 1.82 | 16.4 | |
| Copper | solid | 0.385 | 24.47 | |
| Diamond | solid | 0.5091 | 6.115 | |
| Ethanol | liquid | 2.44 | 112 | |
| Gasoline | liquid | 2.22 | 228 | |
| Gold | solid | 0.1291 | 25.42 | |
| Graphite | solid | 0.710 | 8.53 | |
| Helium | gas | 5.1932 | 20.7862 | 12.4717 |
| Hydrogen | gas | 14.30 | 28.82 | |
| Iron | solid | 0.450 | 25.1 | |
| Lead | solid | 0.127 | 26.4 | |
| Lithium | solid | 3.58 | 24.8 | |
| Magnesium | solid | 1.02 | 24.9 | |
| Mercury | liquid | 0.1395 | 27.98 | |
| Nitrogen | gas | 1.040 | 29.12 | 20.8 |
| Neon | gas | 1.0301 | 20.7862 | 12.4717 |
| Oxygen | gas | 0.918 | 29.38 | |
| Paraffin wax | solid | 2.5 | 900 | |
| Silica (fused) | solid | 0.703 | 42.2 | |
| Uranium | solid | 0.116 | 27.7 | |
| Water | gas (100° C.) | 2.080 | 37.47 | 28.03 |
| | liquid (25° C.) | 4.1813 | 75.327 | 74.53 |
| | solid (0° C.) | 2.114 | 38.09 | |

All measurements are at 25° C. unless otherwise noted. Notable minima and maxima are shown in bold.

In another embodiment, the temperature differential between the black side of the vane (+) and the white side of the vane (−) is maximized by coating each side with materials that have high and low thermal conductivities, respectively. Thermal conductivity (k) is the intensive property that indicates how well a material can conduct heat, and is determined by the following equation: k=heat flow rate×distance/(area×temperature difference). Thus, in one embodiment, the white side of the vanes (−) is coated with a material having a low thermal conductivity. Exemplary materials having a high specific heat and low thermal conductivity include, but are not limited to, cork, wood, rubber, fiberglass, Styrofoam, polystyrene, yittrium oxide, zirconia oxide, aluminum oxide, silica fibre, aerogel, zirconium oxide, or yittrium oxide. In another embodiment, the black side of the vanes (+) is coated with a material with a high thermal conductivity. In another embodiment, the black side of the vanes (+) is coated with a material having a low thermal conductivity. Exemplary materials having a low specific heat and high thermal conductivity include, but are not limited to carbon black, lamp black powder, blackened powder, diamond, and foils, meshes, or sheets of copper, cadmium, zinc, nickel, alloys of nickel, gold, silver, aluminum, brass, or bronze. As such, more heat will be conducted to the black vane (+), while the non-conductive material on the white side (−) will act as a thermal insulator, thereby keeping the white side (−) even cooler. In another embodiment, the coatings of each side consist of granulated powders of the above-discussed materials, the particles of which are attached to the vanes to minimize contact with the vanes and maximize surface contact with the surrounding gas particles. Exemplary sizes of the granulated powders range on the order of submicrons to microns. In addition, granulated powders may be further coated with a paint or black powder (e.g., carbon black) to increase or decrease solar absorption and thermal characteristics, as appropriate.

In another embodiment, light is selectively magnified onto the black side of the vanes by a magnifying lens attached to the casing, embedded within the casing, or attached to the vanes. Such magnification of light will selectively heat the black side of the vanes and amplify the temperature difference between the vanes, thereby causing the vanes to rotate even faster.

FIG. 2 shows another embodiment of the solar electric generator. In this embodiment, the strut 205 hangs from the top portion 125 of the casing 105 along a center axis. At the end of the strut 205 is a stationary, spherical suspension magnet 210 coupled to a rotating, spherical magnetic hub 215 that is strong enough to support the vanes 110, and provide frictionless rotation with an anti-wobble mechanism as described above.

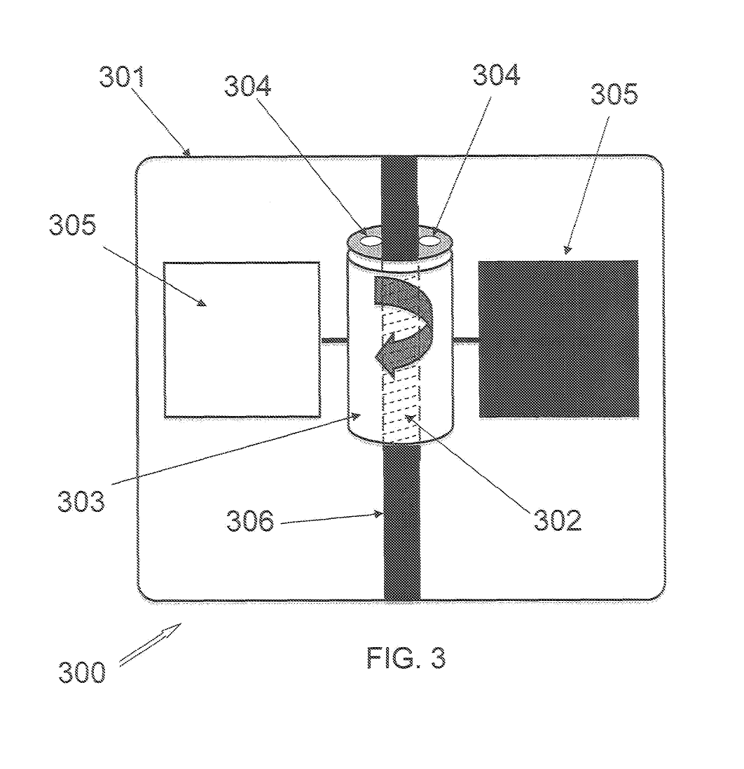

FIG. 3 shows another embodiment of the solar electric generator (300). In this embodiment, the generator includes a sealed cylindrical casing (301) made of a material that allows the energy of sunlight to pass through the casing and further allows the internal temperature to equilibrate with ambient temperature. A central axle (306) is located within the sealed casing along the central vertical axis of the casing. A magnet wire (302) is coiled along a length of the axle, and a plurality of bearings (304) are located on the axle beyond the length of coiled magnet wire flanking the coil of magnet wire. A tubular magnet with alternating poles, the center hollow portion of which is disposed for attachment to the axle by mounting to the bearings, is located over the length of magnet wire. A plurality of vanes (305) having white and black sides, as provided above, are configured to power the rotation of the tubular magnet around the axle. In one embodiment, the bearings are designed to minimize friction during rotation of the tubular magnet. In another embodiment, the bearings are ceramic. In another embodiment, the axle is a hollow tube, thereby providing a passage through which the leads of the magnet wire may pass an electrical current. In yet another embodiment, the casing is of a strength that can withstand the internal vacuum within the casing, as provided below.

Faraday's law (−(constant)Δ magnetic field/Δ time=Current) describes the variables that are necessary to efficiently create an electric current using the principles of the current invention. Thus, there are many key variables in the invention. For example, the power to weight ratio of the magnetized vanes is critical (e.g., the lower the mass and the higher the electromagnetic field produced, the more efficient the device will be). The speed at which the magnetic vanes 110 rotate is critical and is determined by the radius from the center axis of the solar electric generator, the edge area within each porous vane, the shape, width and weight of the vanes 110 as well as the amount of vacuum, the ambient temperature which influences the temperature difference between the sides of the vanes, and the amount of sunlight. The number, direction and gauge of the magnet coils 135 surrounding the magnetic vanes 110 of the SEG (too many will block the sunlight), and the proximity of the coils 135 to the magnetic vanes 110 is also critical. The speed at which the vanes rotate is inversely related to the cube of the radius and can be measured with an optical tachometer. The amount of sunlight (irradiance) can be measured with a spectroradiometer. The maximization of these variables in combination with the frictionless rotation of the magnetized vanes 110 leads to an efficient solar electric generator. Accordingly, the current invention provides lightweight but powerful magnetized vanes 110 that spin up to high rotations per minute (RPM) in close proximity to a large number of coils 135 within depression 130. In one embodiment, the vanes rotate at 1500 to 12000 RPM. In another embodiment, the vanes rotate at 1500 to 3000 RPM. In another embodiment, the vanes rotate at 3000 to 10000 RPM.

In another embodiment, multiple (i.e., more than one) SEGs may be combined to generate event greater amounts of current. One of skill in the art would understand how to satisfy specific energy requirements given the output current of a single SEG.

In another embodiment, the size of the solar electric generator is optimized to maximize the amount of electricity generated. For example, if the SEG is too big, the casing of the generator may be compromised, frictionless rotation may be compromised, and cost of goods and maintenance costs may be prohibitive. Further, a SEG that is too large will be hindered by the number of locations upon which the SEG may be installed. Thus, one of skill in the art would understand that the size of the SEG must be substantial enough to be commercially viable over a given period of time, while minimizing the cost of goods and the cost of maintenance.

As discussed above, rotation of the magnetized vanes depends on the pressure differential between the black and white sides of the vanes created by the energy of light. Depending on the design of the SEG, the electrical energy produced will be 0-90% of the energy causing the rotation per unit time, and should be on the order of 30-40% efficiency, where efficiency %=100%×(current×volts/m²)/(Watts sunlight/m²). Watts sunlight/m² is measured as irradiance.

Accordingly, in one embodiment (as shown in FIG. 2), near frictionless rotation of the hub 215 within the SEG 200 may occur through magnetic suspension of the hub 215 and vanes 110 on a central, stationary spherical magnet 210. In this embodiment, the hub 215 consists of a spherical magnet strong enough to hold the weight of the rotating vanes 110 (see U.S. Pat. No. 6,262,505, incorporated herein by reference). In another embodiment, an anti-wobble mechanism, as described above, is employed on the magnetic hub to prevent wobble of the system. The anti-wobble mechanism depends on the magnetic force attracting the counterbalance 220 to the anti-wobble magnetic base 230 attached to the center of the base of the SEG.

### Example 1

Various prototypes of the SEG have been made and a detectable AC current was produced. Accordingly, the next step is optimizing the power to weight ratio of the magnetized vanes.

In this experiment, the casing was approximately 10 cm high having a dome-like top and a diameter of about 7 cm. Ambient temperature was approximately 84° F., with weak sunlight. Copper wire was coiled around the casing proximate to the rotating vanes at approximately 2.75 cm from the base. The amount of AC generated was 80 microamps using 4 NdFeB magnets (N38) with a BrMax of 12,500 gauss. The irradiance was not measured. Rotations per minute (RPM) were not measured, nor was the proximity to the coiled copper wires. A larger number of stronger and lighter magnets will be used while maximizing the RPM and the number, gauge and material of coiled wires. Also, minimizing the proximity of the wires will help considerably as will minimizing the radius of the vane design.

Although the invention has been described with reference to the above, it will be understood that modifications and variations are encompassed within the spirit and scope of the invention. Accordingly, the invention is limited only by the following claims.

1. A solar electric generator comprising:
a sealed cylindrical casing having a wall, an upper surface, and a base, the casing being made of a material that can withstand a vacuum of 1 torr or less and that allows the energy of light and heat to pass therethrough;
a strut positioned at least partially within the casing along a center axis and coupled to a coil of wire operably associated with a magnet; and
a plurality of vanes configured to rotate the strut, the vanes having a dark side and a light side;
wherein the dark side comprises a first material having a first thermal conductivity and a first specific heat, and the light side comprises a second material having a second thermal conductivity and a second specific heat
wherein the first thermal conductivity is higher than the second thermal conductivity and the first specific heat is lower than the second specific heat.

2. A solar electric generator comprising:
a sealed cylindrical casing having a wall, an upper surface, and a base, the casing being made of a material that can withstand a vacuum of 1 torr or less and that allows the energy of light and heat to pass therethrough;
an axle disposed at least partially within the casing along a central vertical axis of the casing and coupled to a coil of wire operably associated with a magnet;
and
a plurality of vanes configured to rotate the axle, the vanes having a dark side comprising a zinc material and a carbon black material disposed on the zinc material, and a light side comprising an aerogel material.

3. The solar electric generator of claim 1, wherein the casing is made of glass.

4. (canceled)

5. (canceled)

6. The solar electric generator of claim 1, wherein the vanes are porous, the pores having a diameter from submicrons to millimeters, allowing gas to readily pass through.

7. The solar electric generator of claim 1, wherein the vanes are thin.

8. The solar electric generator of claim 7, wherein the vanes are about 0.1 to 10 centimeters thick.

9. The solar electric generator of claim 1, further comprising an inert gas within the casing.

10. The solar electric generator of claim 9, wherein the gas has low mass and viscosity.

11. The solar electric generator of claim 10, wherein the gas has a viscosity of about 0.00013 to 0.0002 Poise.

12. The solar electric generator of claim 9, wherein the gas is Helium.

13. (canceled)

14. (canceled)

15. The solar electric generator of claim 1, wherein the strut engages the base of the casing.

16. (canceled)

17. (canceled)

18. The solar electric generator of claim 1, wherein a vacuum between about 10-60 microtorr is held within the casing.

19. The solar electric generator of claim 1, wherein a magnetized strut is suspended from a top end of the casing.

20. The solar electric generator of claim 19, wherein the strut includes a stationary, spherical suspension magnet, and further comprising a spherical magnetic hub supporting the vanes and an anti-wobble mechanism, thereby providing frictionless rotation.

21. The solar electric generator of claim 20, wherein the anti-wobble mechanism comprises a hollow non-magnetic hub attached to the base, in which bearings are fitted to the counterbalance.

22. (canceled)

23. The solar electric generator of claim 1, wherein the first material having a first thermal conductivity and a first specific heat comprises a metal selected from the group consisting of copper, cadmium, zinc, nickel, alloys of nickel, gold, silver, aluminum, brass, or bronze.

24. The solar electric generator of claim 23, wherein the first material having a first thermal conductivity and a first specific heat further comprises a coating of carbon black, lamp black powder, or blackened powder.

25. (canceled)

26. (canceled)

27. The solar electric generator of claim 24, wherein the second material having a second thermal conductivity and a second specific heat is a lightweight material comprising one or more of cork, wood, rubber, styrofoam, silica fibre or aerogel, zirconium oxide, yittrium oxide and aluminum oxide.

28. (canceled)

29. A method of providing a solar electric generator, comprising:
providing a sealed cylindrical casing having a wall, an upper surface, and a base, the casing being made of a material that can withstand a vacuum of 1 torr or less and that allows the energy of light and heat to pass therethrough;
providing an axle at least partially within the casing positioned along a central vertical axis of the casing;
providing a plurality of vanes having a dark side comprising a first material and a second material disposed on the first material, and a light side comprising a third material;
coupling the vanes to the axle;
coupling a coil of wire to the axle adjacent to a magnet;
wherein the first material comprises one or more of copper, cadmium, zinc, nickel, alloys of nickel, gold, silver, aluminum, brass, or bronze, and the second material comprises a coating of carbon black, lamp black powder, or blackened powder, and the third material comprises a lightweight material of cork, wood, rubber, styrofoam, silica fibre or aerogel, zirconium oxide, yittrium oxide or aluminum oxide.
